(19) United States
(12) Patent Application Publication
(10) Pub. No.: US 2008/0227010 A1
(43) Pub. Date: Sep. 18, 2008

(54) Transfer Paper for Electrophotography

(76) Inventors: Eizo Kurihara, Kanagawa (JP); Tsukasa Matsuda, Kanagawa (JP); Mario Fuse, Kanagawa (JP); Shoji Yamaguchi, Kanagawa (JP); Kunihiro Takahashi, Kanagawa (JP); Tomofumi Tokiyoshi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 11/939,220

(22) Filed: Nov. 13, 2007

(30) Foreign Application Priority Data
Mar. 12, 2007 (JP) 2007-062348

(51) Int. Cl. G03G 7/00

(52) U.S. Cl. 430/104

(57) ABSTRACT

A transfer paper for electrophotography contains a pulp fiber and a magnetic material for generating a large Barkhausen effect. An average dehydration speed S1a (an average value (% by mass/second) of dehydration speeds S1 of 5 sheets of paper) is 0.15 or less. The dehydration speed S1 is represented by (W1a−W1b)/30. Here, W1a represents a moisture content ratio (% by mass) of the paper after moisture conditioning, and W1b represents a moisture content ratio (% by mass) of the paper after a dehydration process including leaving the paper in a 80° C. environment for 30 seconds after moisture conditioning.

### CROSS-REFERENCE TO RELATED APPLICATION

This application is based on and claims priority under 35 USC 119 from Japanese Patent Application No. 2007-62348, filed Mar. 1, 2007.

### BACKGROUND

1. Technical Field

The present invention relates to a transfer paper for electrophotography for a printing operation with a common recording material such as a toner and an ink, and containing a magnetic material for emitting a signal to be detected by a detecting device.

2. Related Art

Conventionally, to prevent forgery and determine the authenticity of printed information, printed matter or documents containing a magnetic material detectable by magnetic signal detectors have been researched extensively.

### SUMMARY

An aspect of a transfer paper for electrophotography according to the present invention contains at least a pulp fiber and a magnetic material for generating a large Barkhausen effect. An average dehydration speed S1a, defined as follows, is about 0.15 or less.

[The average dehydration speed S1a (% by mass/second) denotes an average value of dehydration speeds S1 of 5 sheets of paper, and here the dehydration speed S1 denotes a value represented by the following Formula (1)]:

Dehydration speed S1=(W1a−W1b)/30: Formula (1)

[in Formula (1), W1a represents a moisture content ratio (% by mass) of the paper after moisture conditioning for 12 or more hours in a 23° C./50% RH environment, W1b represents a moisture content ratio (% by mass) of the paper after a dehydration process including leaving the paper in a 80° C. environment for 30 seconds after moisture conditioning for 12 or more hours in a 23° C./50% RH environment, and a constant value shown as the denominator in the formula denotes a time (30 seconds) needed for the dehydration process.]

### BRIEF DESCRIPTION OF THE DRAWINGS

An exemplary embodiment of the present invention will be described in detail based on the following figures, wherein:

FIG. 1 is a graph showing an example of the change in intensity of a pulse signal detected from a paper before and after image formation;

FIGS. 2A to 2C illustrate a graph for explaining a large Barkhausen effect, wherein:

FIG. 2A is a graph showing the B-H characteristic;

FIG. 2B is a graph showing a current generated in a detection coil in the case of generating an alternating magnetic field by an excitor coil, in which the coercivity is plotted in the vertical axis of the upper graph, the current is plotted in the vertical axis of the lower graph, and the time is plotted in the horizontal axis of the upper and lower graphs; and

FIG. 2C is a graph showing the current detected by the detection coil, with the current plotted in the vertical axis and the time plotted in the lateral axis;

FIGS. 3A to 3C are a schematic diagram showing the configuration of a detection gate used for evaluation of Examples, wherein:

FIG. 3A is a front view of the detection gate;

FIG. 3B is a side view of the detecting device constituting the detection gate (observing from the direction of arrow X in FIG. 3A); and

FIG. 3C is a top view of the detecting device constituting the detection gate (observing from the direction of arrow Y in FIG. 3A).

### DETAILED DESCRIPTION

### <Temporary Decline of Pulse Signal Output Immediately After Image Formation>

The inventors have closely studied the phenomenon of the temporary difficulty in detecting a pulse signal immediately after image formation, when forming an image by an electrophotographic method onto a paper containing a magnetic material having a large Barkhausen effect, in order to be able to confirm the presence of the paper even immediately after the image formation by the electrophotographic method.

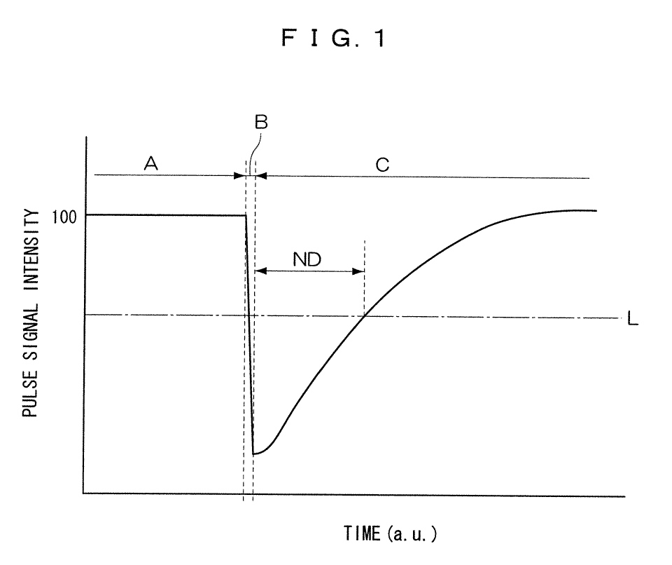

The inventors first examined the change in intensity of a pulse signal detected from the paper before and after image formation. As a result, it was found that the pulse signal intensity changed as shown in FIG. 1.

FIG. 1 is a graph showing an example of the intensity change of the pulse signal detected from the paper before and after image formation. In FIG. 1, the horizontal axis represents time; the vertical axis represents the intensity of the pulse signal detected; the section shown by the mark A denotes the period of time before fixation; the section shown by the mark B denotes the period of time during fixation(a state in which the paper passes through a fixing machine while being heated, which takes about several tens to several hundreds of ms); and the section shown by the mark C denotes the period of time after fixation(after image formation). Moreover, the section shown by the mark ND denotes a state in which the pulse signal is difficult to detect with a detecting device (or a state recognized by the detecting device as “paper absence” due to the pulse signal intensity being at or below a predetermined level).

Moreover, the solid line represents the change of the pulse signal intensity over time for a specific point in the detection area of the detecting device (the solid line in the section shown by the mark B denotes a presumed value), and the line with an alternating dot-dash pattern shown by the mark L denotes the minimum intensity at which a pulse signal is detectable, for a specific point in the detection area of the detecting device (or the intensity at which a detection signal such as an alarm sound or the like is emitted, after it has been determined that a paper has been detected, following determination of the presence or absence of the paper from the detected pulse signal intensity). Although the presence or absence of the section ND and the length thereof depend on the configuration of the detecting device, in general they differ according to the position of the detecting device in the detection area.

As is apparent from FIG. 1, the pulse signal intensity decreases drastically during fixation so as to be at or below the detection limit intensity (or the detection determination intensity) at a specific point in the detection area of the detecting device. Then, it increases (recovers) gradually after fixation, and after a short time (after passage of the section ND), it rises again to the level of detection limit intensity (or the detection determination intensity) or higher. Therefore, when confirming the presence of the paper with the image formed with the detecting device, an area in which it is impossible to detect the paper is generated in the detection area temporarily after the fixation.

This decline in paper detection accuracy (the decline of the detection probability and/or the increase in the area of the detection incapability in the detection area) may be restrained even immediately after image formation by an electrophotographic method onto a paper containing a magnetic material, by means of, for example, setting the detection limit intensity (or the detection determination intensity) to enable paper detection even at a point where the pulse signal intensity immediately after the image formation shows a minimum value. However, in practice, this may increase the operating errors of the detecting device, since noise signal detection also increases. Further, improvement of the specification of the detecting device is required for enabling the detection of a weak pulse signal, and this may not be practical. A method of adding a large amount of the magnetic material in the paper is also conceivable; however, roughness may form on the paper surface due to the magnetic material, so that transfer voids caused by the roughness may easily be generated at the time of image formation.

Therefore, from this point of view, the most effective methods for improving detection appear to be: (1) a method of restraining the decline of the pulse signal intensity during fixation and (2) a method of promoting the increase (recovery) of the pulse signal intensity after fixation.

During fixation, the paper containing a magnetic material is heated by a fixing member such as a fixing roll in a heated state. Since a large amount of moisture in the paper is quickly vaporized by the heat so as to leave the paper dehydrated, contraction stress occurs in the paper. After fixation, the paper gradually absorbs moisture in the atmosphere until the moisture content of the paper reaches an equilibrium state, and the contraction stress of the paper generated during fixation is gradually alleviated.

The drastic generation of contraction stress accompanied by the dehydration-moisture absorption change of the paper before and after fixation, and the slow alleviation process subsequent thereto, tend to coincide with the process of the pulse signal intensity change shown in FIG. 1. Therefore, the inventors have propose that the contraction stress generated in the paper influences the magnetic material so as to bring about the pulse signal intensity change shown in FIG. 1. That is, it is presumed that the large reduction in pulse signal intensity is due to the stress applied to the magnetic material just as a large amount of contraction stress is generated quickly in the paper. Then, if the contraction stress once generated is gradually alleviated, the stress applied to the magnetic material is gradually alleviated as well. It is presumed that pulse signal intensity gradually recovers thereby.

Thus, the inventors propose that (1) restraining the dehydration of the paper due to heat during fixation is important for restraining the decline of the pulse signal intensity during fixation. In addition thereto, the inventors propose that (2) rapid absorption of the moisture in the atmosphere by the paper after the fixation is important for promoting the increase (recovery) of the pulse signal intensity after the fixation.

### <Transfer Paper for Electrophotography>

A transfer paper for electrophotography of the invention (hereafter, the “transfer paper for electrophotography” may be referred to as “transfer paper” or “paper”) contains at least a pulp fiber and a magnetic material for generating a large Barkhausen effect (hereafter, the magnetic material may be referred to simply as “magnetic material”), wherein an average dehydration speed S1a is about 0.15 or less.

The average dehydration speed S1a (% by mass/second) denotes an average value of dehydration speeds S1 of 5 sheets of paper, and here the dehydration speed S1 denotes a value represented by the following Formula (1):

Dehydration speed S1=(W1a−W1b)/30: Formula (1)

[in the Formula (1), W1a represents the moisture content ratio (% by mass) of the paper after moisture conditioning for 12 or more hours in a 23° C./50% RH environment, W1b represents the moisture content ratio (% by mass) of the paper after a dehydration process including leaving the paper in a 80° C. environment for 30 seconds after the moisture conditioning for 12 or more hours in a 23° C./50% RH environment, and the constant value shown as the denominator in the formula denotes a time (30 seconds) needed for the dehydration process].

W1a shown in the Formula (1) denotes “100×(mass of the paper after the moisture conditioning for 12 or more hours in a 23° C./50% RH environment−absolute dry mass of the paper)/absolute dry mass of the paper”, and W1b denotes “100×(mass of the paper after the dehydration process−absolute dry mass of the paper)/absolute dry mass of the paper”.

Here, an oven (trade name: DVS 401, manufactured by Yamato Scientific Co., Ltd.) was used for the dehydration process of the paper, and air at 23° C./50% RH was heated to 80° C./at the time of the dehydration process.

Moreover, the absolute dry mass of the paper was obtained by heating the paper in an oven (trade name: DVS 401, manufactured by Yamato Scientific Co., Ltd.) of 105° C./for 5 or more hours, radiating heat for 30 minutes with the paper placed in a desiccator, and measuring the mass of the paper after the heat radiation process.

The mass of the paper processed by each condition was measured with a balance (trade name: AB204S, manufactured by METTLER-TOLEDO K.K.), and the size of the paper used for a series of measurements and evaluations was A4 size.

The average dehydration speed S1a is about 0.15% by mass/second or less, and preferably about 0.14% by mass/second or less.

When the average dehydration speed S1a is more than about 0.15% by mass/second, the contraction stress generated in the paper increases due to the drastic vaporization of the moisture from the paper during fixation, which causes a remarkable decline in the pulse signal intensity. In this case, the decline of the detection accuracy of the paper immediately after the image formation may not be restrained.

On the other hand, the lower limit of the average dehydration speed S1a, although not particularly limited thereto, is in practice preferably about 0.08% by mass/second or more, and more preferably about 0.10% by mass/second or more for avoiding difficulties in the production of the paper itself, or the like.

Here, the average dehydration speed S1a represents the dehydration characteristic when the paper is heated, and specifically, it is obtained as the average value of the dehydration speeds S1 calculated as shown by the Formula (1).

In the Formula (1), W1a denotes a moisture content ratio of the paper in a state before fixation (in the example shown in FIG. 1, the state shown by section A), and the moisture conditioning state (23° C./50% RH) at the time of measuring W1a is assumed to be a common environment in which an image forming apparatus is placed.

Moreover, W1b denotes a pseudo-reproduction of the moisture content ratio of the paper in a state immediately after finishing fixation (in the example shown in FIG. 1, the state at a boundary position between the section B and the section C).

The dehydration conditions (dehydration process at 80° C. for 30 seconds) for obtaining W1b are of a lower temperature and longer time than ordinary fixing conditions. This is because of the extreme difficulty in measuring the moisture content ratio in a paper immediately after carrying out an ordinary fixing process with good reproductivity, in consideration of, for example, the time it takes to transfer a paper from a fixing device to a measuring device. Therefore, the inventors have reasonably assumed that appropriate dehydration conditions capable of providing a pseudo-reproduction of the dehydration state at the time of fixation are 80° C. 30 seconds.

That is, the dehydration temperature was set to 80° C. because the temperature of the entirety of the paper is presumed to be about 80° C. which is lower than the fixing temperature due to a temperature difference generated between the inner part and the surface of the paper at the time of fixation.

Moreover, the dehydration time was set to 30 seconds for the following reasons. First, the heating operation at the time of fixation is direct heating by contacting a fixing member, serving also as a heat source, with the paper (solid contact heating). Therefore, the operation of applying thermal energy of a predetermined amount to the paper takes only a short time. On the other hand, the dehydration conditions at the time of obtaining W1b include indirect heating in an oven. Therefore, for applying an amount of thermal energy as close as possible to the total amount of thermal energy to be applied to the paper at the time of fixation, a longer time than the fixing time seems to be needed. From the viewpoint of ensuring the reproductivity of the measurement value, a longer heating time is preferable. However, if the heating time is too long, it may result in discrepancy between the dehydration characteristics of the paper when carrying out the dehydration process, and the dehydration characteristics of the paper when carrying out fixation. For this reason, the inventors set the moisture conditioning time to 30 seconds to secure the reproductivity of the measurement values in addition to the reason mentioned above.

Examples of a method for controlling the average dehydration speed S1a at about 0.15 or less generally include, although not being particularly limited thereto, a method of improving the moisture retention property of the paper, and a method of inhibiting the moisture movement and diffusion in a paper thickness direction.

Examples of the former method include addition of a moisture retaining agent to the paper. Examples of the latter method include a method of providing a barrier layer having a function of inhibiting the moisture diffusion in a paper thickness direction for maintaining the moisture retaining property of the paper at as high a level as possible even under the heating process during fixation, and a method of enlarging the stochigt sizing degree of the paper (for at least the layer containing the magnetic material). Details of these methods will be described later.

A transfer paper for electrophotography of the invention contains at least a pulp fiber and a magnetic material for generating a large Barkhausen effect, and has an average moisture absorbing speed S2a of about 0.045 or more.

The average moisture absorbing speed S2a (% by mass/second) denotes an average value of moisture absorbing speeds S2 of 5 sheets of paper and here the moisture absorbing speed S2 denotes a value represented by the following Formula (2):

Moisture absorbing speed S2=(W2b−W2a)/30: Formula (2)

[in the Formula (2), W2a represents a moisture content ratio (% by mass) of the paper after moisture conditioning for 12 or more hours in a 10° C./15% RH environment, W2b represents a moisture content ratio (% by mass) of the paper after moisture absorbing process including leaving the paper in a 28° C./85% RH environment for 30 seconds after moisture conditioning for 12 or more hours in a 10° C./15% RH environment, and the constant value shown as the denominator in the formula denotes a time (30 seconds) needed for the moisture absorbing process.

W2a shown in the Formula (2) denotes “100×(mass of the paper after moisture conditioning for 12 or more hours in a 10° C./15% RH environment−absolute dry mass of the paper)/absolute dry mass of the paper”, and W2b denotes 100×(mass of the paper after the moisture absorbing process−absolute dry mass of the paper)/absolute dry mass of the paper”.

The method of processing the paper for measuring the absolute dry mass, the method of measuring the mass of the paper, and the size of the paper used for a series of measurement and evaluation are same as those shown in Formula (1).

The average moisture absorbing speed S2a is about 0.045% by mass/second or more, and it is preferably about 0.05% by mass/second or more.

If the average moisture absorbing speed S2a is less than about 0.045% by mass/second, moisture in the atmosphere cannot be absorbed by the paper after fixation, and it becomes difficult to alleviate contraction stress generated in the paper during fixation, resulting in large delay in the increase (recovery) of pulse signal intensity. Consequently, the decline of the detection accuracy of the paper immediately after the image formation may not be restrained.

On the other hand, the upper limit value of the average moisture absorbing speed S2a, although not particularly limited thereto, is in practice preferably about 0.10% by mass/second or less, and more preferably about 0.09% by mass/second or less for avoiding difficulties in the production of the paper itself, or the like.

Here, the average moisture absorbing speed S2a represents the moisture absorbing characteristic of the paper in a state with a low moisture content ratio, such as immediately after fixation, and specifically, it is obtained as the average value of the moisture absorbing speeds S2 calculated as shown by the Formula (2).

For the accurate evaluation of the moisture absorbing characteristic inherent to the paper, it is considered more effective to evaluate the moisture absorbing characteristic by an accelerated test, rather than evaluating the moisture absorbing characteristic by a moisture absorbing test based on the temperature and humidity conditions after fixation.

The reason for this, is that the moisture content ratio of the paper immediately after fixation (indicated in FIG. 1 by the state at a boundary position between the section B and the section C) is irregular to some extent depending on the kind of paper used and the fixing conditions. That is, it is difficult to fix the moisture content ratio of the paper before the moisture absorbing process.

If the paper is moved (by being taken out by a person, or the like) after fixation so that the humidity of the atmosphere surrounding the paper is fluctuates (for example, the detecting device is arranged at an entrance in the vicinity of a door, or the like), the moisture content ratio of the paper may be irregular to some extent. That is, it is difficult to fix the moisture content ratio of the paper after the moisture absorbing process.

For this reason, the inventors have selected the temperature and humidity conditions at the time of measuring W2b and W2a to be used for the calculation of the moisture absorbing speed S2 such that the moisture content ratio of the paper before the moisture absorbing process may be as small as possible, and the moisture content ratio of the paper after the moisture absorbing process may be as large as possible.

If the moisture absorbing process time shown in Formula (2) is too short, the reproductivity of the measurement value (W2b) decreases. If, on the other hand, the moisture absorbing process time is too long, then there is more risk of carrying out the moisture absorbing process not only in a state in which the moisture content ratio of the paper is increased, but also in a state of high saturation, so that the discrepancy of the moisture absorbing speed S2 calculated with respect to the true value may be too large. Therefore, to balance these effects, the moisture absorbing process time is set to 30 seconds.

Examples of a method for controlling the average moisture absorbing speed S2a to about 0.045 or more include, although not particularly limited thereto, a method of not adding a filler to the paper as a component to inhibit the moisture absorption of the pulp fiber contained in the paper, and a method of restraining the content of the filler, if the paper contains a filler.

Further examples thereof also include a method of reducing the density of the paper for facilitating the movement of water molecules in the atmosphere from the outside of the paper to the inside of the paper, and a method of adding a moisture absorbing agent to the paper. Details of these methods will be described later.

### —Average Dehydration Speed S1a and Average Moisture Absorbing Speed S2a—

As heretofore explained, the paper of the invention may have the condition that <1> the average dehydration speed S1a is about 0.15 or less, or <2> the average moisture absorbing speed S2a is about 0.045 or more. For restraining the decline of the detection accuracy of the paper immediately after the image formation more effectively, it is preferable to satisfy the above conditions <1> and <2> at the same time.

The paper of the invention contains at least a pulp fiber and a magnetic material for generating a large Barkhausen effect, wherein a dehydration and moisture absorbing speed ratio R defined by the following Formula (3) is about 0.3 or more. In this case, it is further preferable that at least one of the above conditions <1> and <2> is satisfied in addition to satisfying further conditions that the dehydration and moisture absorbing speed ratio R is about 0.3 or more.

Dehydration and moisture absorbing speed ratio R=|average moisture absorbing speed S2a/average dehydration speed S1a|: Formula (3)

[in the Formula (3), the average dehydration speed S1a (% by mass/second) denotes an average value of dehydration speeds S1 of 5 sheets of paper, and here the dehydration speed S1 denotes a value represented by the above-mentioned Formula (1), while the average moisture absorbing speed S2a (% by mass/second) denotes an average value of moisture absorbing speeds S2 of 5 sheets of paper, and here the moisture absorbing speed S2 denotes a value represented by the above-mentioned Formula (2)].

The dehydration and moisture absorbing speed ratio R is preferably about 0.3 or more, more preferably about 0.32 or more, and even more preferably about 0.35 or more. In the case where the dehydration and moisture absorbing speed ratio R is less than about 0.3, it may be difficult to effectively restrain the decline of the detection accuracy of the paper immediately after image formation.

The upper limit value of the dehydration and moisture absorbing speed ratio R, although not particularly limited thereto, is in practice preferably about 1.0 or less, and more preferably about 0.7 or less.

Next, the constituent materials of the paper of the invention, the production method, the various physical properties, and the like will be explained in more detail.

### —Magnetic Material—

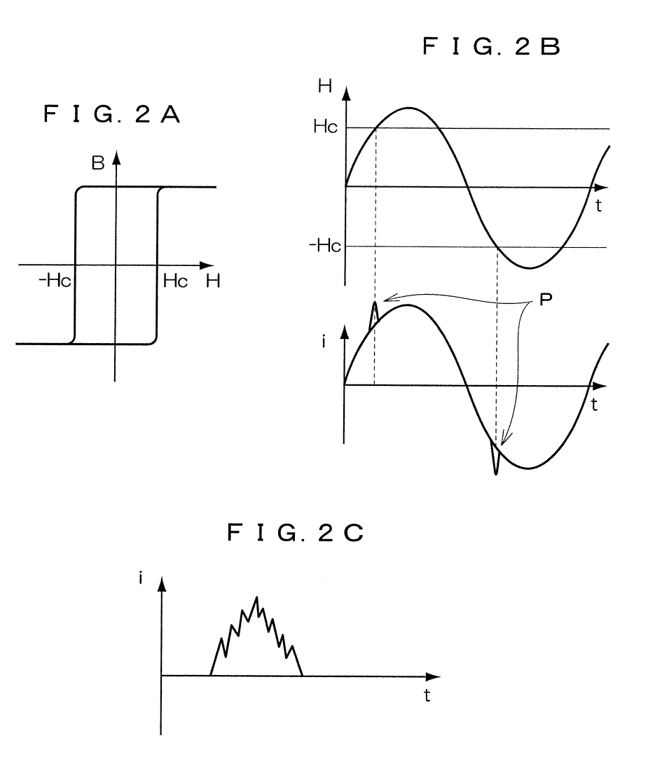

A material having a large Barkhausen effect is used as the magnetic material contained in the paper of the invention. Here, the large Barkhausen effect will be explained simply. FIG. 2 is a graph for explaining the large Barkhausen effect. The large Barkhausen effect is a phenomenon wherein steep magnetic inversion is generated at the time of placing, in an alternating magnetic field, a material having the B-H characteristic shown in FIG. 2A, i.e. a hysteresis loop with a substantially rectangular shape and a relatively small coercivity (Hc), such as an amorphous magnetic material made of Co—Fe—Ni—B—Si. Therefore, if an alternating magnetic field is generated by supplying an alternating current to an excitor coil, and the magnetic material is placed in the alternating magnetic field, a pulse-like current can be supplied to a detection coil arranged in the vicinity of the magnetic material at the time of the magnetic inversion.

For example, if the alternating magnetic field as shown in the upper part of FIG. 2B is generated by an excitor coil, the pulse current shown in the lower part of FIG. 2B is supplied to the detection coil. The peak shown by the mark P in FIG. 2B represents the pulse current that accompanies the magnetic inversion.

However, the current supplied to the detection coil also includes an alternating current induced by the alternating magnetic field. Therefore, the pulse current is detected while it is superimposed on the alternating current. Moreover, if a material containing plural magnetic materials is placed in the alternating magnetic field, plural pulse currents are superimposed such that the current shown by FIG. 2C is detected.

Examples of the magnetic material to be contained in the paper of the invention include, in general, rare earth based materials containing a permanent magnet such as neodymium (Nd)-iron (Fe)-boron (B), a magnetic material mainly containing samarium (Sm)-cobalt (Co), an alnico based magnetic material mainly containing aluminum (Al)-nickel (Ni)-cobalt (Co), a ferrite based magnetic material mainly containing barium (Ba) or strontium (Sr) and an iron oxide (Fe₂O₃), a soft magnetic material, and an oxide soft magnetic material, and it is preferable to use an amorphous magnetic material of a basic composition of Fe—Co—Si or Co—Fe—Ni.

The shape of the magnetic material is not particularly limited as long as it is a long narrow shape suitable for generating a large Barkhausen effect; however, a predetermined length with respect to the cross-sectional area is required for generating a large Barkhausen effect. For this reason, a substantially fiber-like shape such as a wire-like shape or a band-like shape is preferable, and a wire-like shape is more preferable.

If the magnetic material is a wire-like magnetic substance wire, as mentioned above, its diameter is preferably about 10 μm or more for generating a large Barkhausen effect. The largest diameter is preferably about 90 μm or less, and more preferably about 80 μm or less. If the diameter is more than about 90 μm, the magnetic material may project to the surface of the paper even if the magnetic material is contained inside the paper.

The length of the magnetic substance wire is preferably about 10 mm or more for generating the large Barkhausen effect. The maximum length of the magnetic substance wire may be any length as long as it does not emerge from the paper so as to be exposed at the time the magnetic substance wire is contained inside. Although not particularly limited, the length is preferably about 430 mm or less.

It is preferable that the diameters and the lengths of the all magnetic substance wires contained in the paper satisfy the above-mentioned ranges. However, if the values of the diameters and the lengths of the magnetic substance wires have a distribution, the average values preferably satisfy the above-mentioned ranges.

### —Method and Devices for Detecting the Paper—

Since the paper of the invention contains the above-mentioned magnetic material, the presence of the paper can be confirmed by detecting an electric signal (such as the pulse signal shown in FIG. 2) generated in the magnetic material when the paper is placed in a magnetic field by means of a detecting device.

The configuration and usage mode of the detecting device are not particularly limited as long as the above-mentioned electric signal can be detected in some form. In the invention, however, it is preferable to use a detecting device having a pair of non-contact type detecting units fixed at a predetermined position so as to have a width to the extent that a person can pass by therebetween (hereafter, it may be referred to as “detecting gate”).

In the detecting gate, a detection area is formed between the pair of detecting units. This enables the presence of the paper to be sensed if the paper of the invention passes through the detecting gate. Detection of the presence of the paper by the detecting gate may be utilized, for example, for the prevention of illegal copying or illegal appropriation of classified information formed on the paper as an image. However, the uses of the paper of the invention are not limited to the above-mentioned applications.

### —Paper Base Material—

Next, the paper base material will be explained. The paper of the invention includes a paper base material containing a pulp fiber and a magnetic material. The paper base material may have two or more layers, and as needed, a surface layer such as a pigment coating layer may be provided on at least one side of the paper base material.

Preferable examples of the pulp fiber used as the main component of the paper base material include, although not particularly limited thereto, a kraft pulp fiber of a broadleaf tree and/or a conifer, a sulfite pulp fiber, a semi-chemical pulp fiber, a chemi-ground pulp fiber, a pulverized wood pulp fiber, a refiner ground pulp fiber, and a thermo-mechanical pulp fiber. A fiber with cellulose or hemi-cellulose contained in these fibers chemically modified may be also used as needed.

Furthermore, various fibers such as a cotton pulp fiber, a linen pulp fiber, a kenaf pulp fiber, a bagasse pulp fiber, a viscose rayon fiber, a reproduced cellulose fiber, a copper ammonia rayon fiber, a cellulose acetate fiber, a polyvinyl chloride based fiber, a polyacrylonitrile based fiber, a polyvinyl alcohol based fiber, a polyvinylidene chloride based fiber, a polyolefin based fiber, a polyurethane based fiber, a fluorocarbon based fiber, a glass fiber, a carbon fiber, an alumina fiber, a metal fiber, and a silicon carbide fiber may be used alone or in a combination of two or more.

As needed, it is possible to use a fiber obtained by impregnating the above-mentioned pulp fibers with a synthetic resin such as polyethylene, polypropylene, polystyrene, polyvinyl chloride, and polyester or by thermally fusing the same thereto. By doing so, the Taber abrasion amount and the internal bond strength can be improved.

Further, a high grade or medium grade used pulp may be mixed in the above-mentioned pulp fibers. The amount of the used pulp mixed may be determined according to the application, the purpose, or the like. For example, when mixing in used pulp to conserve resources, preferably about 10% by mass or more of the used pulp, and more preferably about 30% by mass or more of the used pulp may be mixed with respect to all the pulp fibers contained in the paper base material.

The kind of the filler to be used for the paper base material is not particularly limited, and examples thereof include a calcium carbonate based filler such as heavy calcium carbonate, light calcium carbonate, and chalk; an inorganic filler such as silicates including kaolin, based clay, pyrophillite, sericite and talc, titanium dioxide, calcium sulfate, barium sulfate, zinc oxide, zinc sulfate, zinc carbonate, aluminum silicate, calcium silicate, magnesium silicate, synthetic silica, aluminum hydroxide, alumina, white carbon, saponite, dolomite, calcium montmorillonite, sodium montmorillonite, and bentonite; an organic filler such as an acrylic based plastic pigment, polyethylene, chitosan particles, cellulose particles, polyamino acid particles, and styrene to improve the image maintaining properties and the level of whiteness in the electrophotographic method, it is preferable to mix in calcium carbonate in an acid-free paper production process.

Further, various chemicals such as a sizing agent may be added internally or externally to the paper base material constituting the paper of the invention.

Examples of the sizing agent to be added to the paper base material include sizing agents such as a rosin based sizing agent, a synthetic sizing agent, a petroleum resin based sizing agent and a neutral sizing agent. A combination of a sizing agent such as aluminum sulfate and cationized starch, and a fixing agent may be used as well.

To improve the storage properties of the paper after an image is formed with an image forming apparatus of the electrophotographic method, it is preferable to use a neutral sizing agent from among the above-mentioned sizing agents, such as an alkenyl succinic anhydride based sizing agent, an alkyl ketene dimer, an alkenyl ketene dimer, neutral rosin, a petroleum sizing agent, an olefin based resin, and a styrene-acrylic based resin. Examples of the surface sizing agent include a cellulose modified product such as oxidized modified starch, enzyme modified starch, polyvinyl alcohol and carboxy methyl cellulose; styrene-acrylic based latex; styrene-maleic acid based latex; and acrylic based latex, which may be used alone or in combination.

Furthermore, a paper durability strengthening agent may be added internally or externally to the paper base material containing the paper of the invention.

Examples of the paper durability strengthening agent include starch, modified starch, plant gum, carboxy methyl cellulose, polyvinyl alcohol, modified polyvinyl alcohol, polyacrylic amide, a styrene-maleic anhydride copolymer, a vinyl chloride-vinyl acetate copolymer, a styrene-butadiene copolymer, polyacrylic ester urea, a formaldehyde resin, a melamine-formaldehyde resin, dialdehyde starch, polyethylene imine, epoxidized polyamide, a polyamide-epichlorohydrin based resin, methylolized polyamide, and a chitosan derivative, which may be used alone or as a mixture.

A feature of the paper of the invention is that a moisture retaining agent is added to the paper base material. Since the moisture retaining agent is added to the paper base material, the average dehydration speed S1a may be maintained at about 0.15 or less by reducing the average dehydration speed S1a.

The content of the moisture retaining agent is preferably more than 0 parts by mass, more preferably about 10 parts by mass or more, and further preferably about 15 parts by mass or more, with respect to 100 parts by mass of the pulp fibers contained in the paper. If the moisture retaining agent is not used, it is difficult to restrain the decline in the detection accuracy of the paper. The upper limit of the content of the moisture retaining agent, although not particularly limited thereto, is in practice preferably about 50 parts by mass or less, more preferably about 45 parts by mass or less, and further preferably about 40 parts by mass or less, with respect to 100 parts by mass of the pulp fibers contained in the paper.

Examples of the moisture retaining agent to be used include glycerol, alkane diols, alkane triols, plant extracts, honey, 1,1,1-tris(hydroxyl methyl)propane, saccharides such as monosaccharide and oligosaccharide, and sugar alcohol.

Examples of the monosaccharides include D- and L-fructose, tagatose, sorbose, ribose, xylose, arabinose, lyxose, glucose, mannose, allose, altrose gylose, idose, galactose, talose, and gulose.

Examples of the oligosaccharides include maltose, lactose, sucrose, raffinose, gentianose, stachyose, and xylan.

Examples of the sugar alcohols include tetritol, D- and L-erythritol, arabinitol, xylitol, adonitol, ribitol, D-sorbitol, allitol, D-mannitol, D-iditol, D-talitol, dulcitol, and heptitol.

As to the moisture retaining agent, a substance having moisture retaining ability other than the above-listed substances may also be used. Specifically, it is preferable to use a substance having a moisture retaining ratio of about 1.5 or more.

Here, the moisture retaining ratio is represented by the following Formula (4):

Moisture retaining ratio=(conditioned moisture level of a paper with a substance having moisture retaining ability coated by 1 g/m2)/(conditioned moisture level of an unprocessed paper). Formula (4)

The moisture retaining ratio is calculated by the Formula (4) after measuring the conditioned moisture level of a paper obtained by coating a filtrating paper with an aqueous solution containing a substance having moisture retaining ability (concentration of the substance having moisture retaining ability: 10% by mass) so as to have a solid component of about 1.0 g/m2, and the conditioned moisture level of an unprocessed paper (filtrating paper) not coated with an aqueous solution of a substance having moisture retaining ability.

The conditioned moisture level is measured in an environment based on Japanese Industrial Standard JIS-P-8111:1998 (temperature: 23° C., relative humidity: 50%) after moisture conditioning of the paper coated with the aqueous solution containing the substance having moisture retaining ability and the unprocessed paper for 24 hours or more.

The conditioned moisture level of the paper shown by the Formula (4) was measured based on JIS-P-8127:1998.

To increase the average moisture absorbing speed S2a so as to maintain the average moisture absorbing speed S2a at about 0.045 or more, a moisture absorbing agent may be added to the paper base material. In this case, the content of the moisture absorbing agent is preferably more than 0 parts by mass, more preferably about 10 parts by mass or more, and further preferably about 15 parts by mass or more, with respect to 100 parts by mass of the pulp fibers contained in the paper. If the moisture absorbing agent is not used, the average moisture absorbing speed S2a cannot be maintained at about 0.045 or more, so that it is difficult to restrain the decline of the detection accuracy of the paper. The upper limit of the content of the moisture absorbing agent, although not particularly limited thereto, is in practice preferably about 50 parts by mass or less, more preferably about 45 parts by mass or less, and further preferably about 40 parts by mass or less, with respect to 100 parts by mass of the pulp fibers contained in the paper.

The moisture absorbing agent to be used is not particularly limited as long as it is a substance having high moisture absorbing ability, and examples thereof include silica gel and Na₂SO₄.

In addition to the above-listed various components, various auxiliary agents to be contained in a common paper medium, such as a dye and a pH adjusting agent, may be used with the paper base material as needed.

In the production of the paper of the invention, a paper having a desired layer configuration can be produced via the method for producing the material constituting the paper base material, or via the order of the materials, or by providing a surface layer to the paper base material as needed.

As an example, the material constituting the paper base material such as the above-mentioned pulp fiber is mixed to produce a paper material slurry, thereby manufacturing a paper base material layer. Then, a paper base material is manufactured by the process of dispersing and arranging a magnetic material onto one side of the paper base material layer, and attaching another paper base material layer onto the surface with the arranged magnetic material. Furthermore, as needed, a surface layer may be provided on the surface of the paper base material.

A paper material slurry containing a magnetic material in the material constituting the paper base material such as the pulp fiber may be produced to manufacture a single layer of paper base material, and a surface layer may be provided as needed on the surface of the paper base material. Alternatively, a paper base material layer produced by using a paper material slurry containing no magnetic material may be attached on both sides of a paper base material layer containing a magnetic material to manufacture a paper base material with a three layer configuration. Furthermore, as needed, a surface layer may be provided on the surface of the paper base material. Accordingly, the paper base material may be manufactured utilizing a multiple layer paper, or the paper may be manufactured by further forming a surface layer.

Although the paper of the invention may have a single layer configuration having only one layer of the paper base material, it preferably has two or more layers. In this case, the paper base material itself may have two or more layers, a surface layer may be provided on one side or both sides of the paper base material, or a configuration of a combination thereof may be employed.

If the paper base material has two or more layers, arrangement of the magnetic material at the interface between the layers makes it possible to prevent exposure of the magnetic material to the paper surface, and also allows the magnetic material to be contained at a position on the inner side of the paper surface.

In the case where the paper base material has three or more layers, the magnetic material may be contained inside a layer or between layers but not in the outermost layer of the paper base material, whereby the magnetic material can be contained at the inner side of the paper surface. In this case, the most preferable layer configuration is one that has at least two or more layers of the paper base material layer containing at least a pulp fiber, with the two paper base material layers laminated adjacently together, and a magnetic material arranged at the boundary of the two paper base material layers.

To prevent the magnetic material protruding so as to be exposed on the paper surface, and to arrange the magnetic material at the inner side of the paper surface, it is also preferable to provide a surface layer. It is effective to provide a surface layer particularly when the paper base material has a single layer configuration.

As heretofore explained, a desired configuration of the layer configuration in the thickness direction of the paper can be obtained by selecting and combining the paper production processes as needed.

To reduce the average dehydration speed S1a so as to maintain the average dehydration speed S1a at about 0.15 or less, the paper of the invention preferably has a barrier layer.

Here, the barrier layer denotes a layer having a function of inhibiting movement or diffusion of the water molecules existing in the paper to the paper surface with respect to a paper thickness direction. Specifically, it denotes a layer containing at least one kind of barrier material selected from a resin and an adhesive (however, the content of the barrier material in the barrier layer is about 30% by mass or more and about 100% by mass or less).

The barrier layer mav have the above-mentioned function of inhibiting the movement and diffusion of the water molecules in the paper as well as other functions. It is most preferable that the barrier layer is made of only a barrier material in order to perform the function of inhibiting the movement and diffusion of the water molecules in the paper more effectively. The thickness of the barrier layer, although not particularly limited thereto, is preferably about 1 μm or more, and more preferably about 2 μm or more to effectively inhibit the movement and diffusion of the water molecules in the paper while the upper limit value of the thickness of the barrier layer, although not particularly limited thereto, is in practice preferably about 25 μm or less.

A barrier layer may be arranged on both sides of a layer containing a pulp fiber and a magnetic material (the layer denotes two layers on an interface if the magnetic material is arranged at the interface of the two layers). For example, in the case where a barrier layer is arranged on both sides of a paper base material containing a pulp fiber and a magnetic material, the barrier layer may be provided so as to directly contact the paper base material surface, or the barrier layer may be provided on another layer such as a pigment coating layer provided in contact with the surface of the paper base material. In this case, it is preferable that the barrier layer is a resin layer mainly containing a resin.

In the case where a paper base material has three paper base material layers and a magnetic material is contained only in the paper base material layer arranged at a central position with respect to a paper thickness direction, a barrier layer may be provided between the paper base material layer arranged at the central position and the paper base material layers arranged on either or both sides of the paper base material layer. In this case, the barrier layer is preferably an adhesive layer mainly containing an adhesive in order to bond the two paper base material layers.

A known thermoplastic resin or adhesive may be utilized as the barrier material constituting the barrier layer. As the thermoplastic resin, those used for the resin layer to be described later can be utilized. As the adhesive, those used for the pigment coating layer to be described later can be utilized.

The paper production method for manufacturing the paper base material (or the paper base material layer) is not particularly limited. Any of a multiple layer paper production method a conventionally known Fourdrinier paper machine, a cylinder paper machine, and a twin wire system can be used. Either an acidic or acid-free paper production method can be employed.

Usable examples of the method for producing a multiple layer paper include a multicylinder papermaking, a Fourdrinier multicylinder, a combination of a Fourdrinier and a cylinder, a multi head box, and a direct wire or Fourdrinier system. For example, any of the methods disclosed in details in “Saishin Shoshi Gijutsu—Riron to Jissai” (The Latest Paper Making Techniques—Theory and Practice), Saburo Ishiguro, Seishi Kagaku Kenkyujo Paper Production Science Research Institute), 1984) can be used, and orb web multicylinder type such that plural orb webs are lined up may be used.

A sizing agent may be added as needed to the surface of a paper base material (the surface of the outermost paper base material layer in the case where a paper base material of a paper is provided with plural paper base material layers), to improve the surface strength, as long as the absorption of an aqueous liquid is not inhibited. Examples of sizing agents include a rosin based sizing agent, a synthetic sizing agent, a petroleum resin based sizing agent and a neutral sizing agent. Further, a fixing agent such as aluminum sulfate and cationized starch may be used in a combination between the sizing agent and the pulp fiber.

Also, it is preferable that the size press solution shown below is coated on the surface of the paper base material (the surface of the outermost paper base material layer in the case where the paper base material of the paper is provided with plural paper base material layers).

Examples of the binder used for the size press solution may include unprocessed starch such as corn starch, potato starch, and tapioca starch; and processed starch such as enzyme modified starch, phosphate starch, cationized starch, and acetylated starch. Examples thereof further include, although not limited thereto, a water soluble polymer such as polyethylene oxide, polyacrylamide, sodium polyacrylate, sodium alginate, hydroxyl methyl cellulose, carboxy methyl cellulose, methyl cellulose, polyvinyl alcohol, guar gum, casein, and curdlan and derivatives thereof, which may be used alone or as a mixture. However, starch is often used for its inexpensiveness from the viewpoint of production costs.

The paper of the invention also contains a magnetic material. Thus, in the case where the surface of the magnetic material is not covered with an insulating layer made of a resin, a metal oxide, or the like, the electric resistance in the periphery of the magnetic material can easily be lowered. For this reason, in the case of forming an image by the electrophotographic method local transfer failure occurs in the periphery of the portion where the magnetic material exists at the time of transferring a toner image formed on the surface of a photosensitive member or an intermediate transfer member, with the result that a void in the image may occur.

Accordingly, it is preferable to adjust the surface resistance ratio or the volume resistance ratio of the paper to within a predetermined range so as to prevent occurrence of the void. For adjusting the electric resistance, an electric resistance adjusting agent may be used for the paper of the invention. Examples of the electric resistance adjusting agent include inorganic substances such as sodium chloride, potassium chloride, calcium chloride, sodium sulfate, zinc oxide, titanium dioxide, tin oxide, aluminum oxide, and magnesium oxide; and organic materials such as alkyl phosphate salt, alkyl sulfate salt, sodium sulfonate salt and quaternary ammonium salt, which may be used alone or in combination. Examples of a method for allowing these electric resistance adjusting agents to be contained in the paper include a method of mixing the inorganic substances or organic materials in the above-mentioned size press solution to apply the mixed solution on the above-mentioned paper base material surface.

Examples of the method for applying the size press solution on the paper base material surface (the surface of the outermost paper base material layer in the case where the paper base material of the paper has plural paper base material layers) include not only the size press, but also an ordinarily used coating machine such as seam size, gate roll, roll coater, bar coater, air knife coater, rod blade coater and blade coater.

Further, a coating solution made mainly of an adhesive and a pigment may be coated on at least one side of the paper of the invention to form a pigment coating layer, and the paper having the pigment coating layer may be used as a coated paper.

For obtaining a highly glossy image, a resin layer may be provided on the pigment coating layer.

The resin used for the resin layer is not particularly limited as long as it is a known thermoplastic resin. Examples of the resin include a resin having an ester bond; a polyurethane resin; a polyamide resin such as a urea resin; a polysulfone resin; a polyvinyl chloride resin, a polyvinilidene resin, a vinyl chloride-vinyl acetate copolymer resin, a vinyl chloride-vinyl propionate copolymer resin; a polyol resin such as polyvinyl butylal, a cellulose resin such as an ethyl cellulose resin and a cellulose acetate resin; a polycaprolactone resin, a styrene-maleic an hydride resin, a polyacrilonitrile resin, a polyether resin, an epoxy resin, a phenol resin; a polyolefin resin such as a polyethylene resin and a polypropylene resin, a copolymer resin of olefin such as ethylene and propylene and another vinyl monomer, and an acrylic resin.

A polymer compound of either water soluble or water dispersible, or both thereof can be used as the adhesive to be contained in the pigment coating layer coating solution. Examples of the adhesive include starch such as cationic starch, amphoteric starch, oxidized starch, enzyme modified starch, thermo-chemically modified starch, esterized starch, and etherized starch: a cellulose derivative such as carboxy methyl cellulose and hydroxyl ethyl cellulose; a natural or semi-synthesized polymer compound such as gelatin, casein, soy protein and natural rubber; polydienes such as polyvinyl alcohol, isoprene, neoprene, and polybutadiene; polyalkenes such as polybutene, polyisobutylene, polypropylene, and polyethylene; vinyl polymer or copolymers such as vinyl halide, vinyl acetate, styrene, (meth)acrylic acid, (meth)acrylate, (meth)acrylamide, and methyl vinyl ether; styrene-butadiene based, or methyl methacrylate-butadiene based synthetic rubber latex; and a synthetic polymer compound such as a polyurethane resin, a polyester resin, a polyamide resin, an olefin-maleic anhydride resin and a melamine resin. One kind or two or more kinds among these may be selected and used according to the desired quality of the paper.

Examples of the pigment to be contained in the pigment coating layer coating solution include a mineral pigment such as heavy calcium carbonate, light calcium carbonate, kaolin, baked kaolin, structural kaolin, delami kaolin, talc, calcium sulfate, barium sulfate, titanium dioxide, zinc oxide, alumina, magnesium carbonate, magnesium oxide, silica, almino magnesium silicate, fine particle calcium silicate, fine particle magnesium carbonate, fine particle light calcium carbonate, white carbon, bentonite, zeolite, sericite and smectite; organic pigments such as a polystyrene resin, a styrene-acrylic copolymer resin, a urea resin, a melamine resin, an acrylic resin, a vinylidene chloride resin, a benzoguanamine resin as well as a minute hollow particle thereof or through type thereof, and among them one kind or two or more kinds may be selected to be used.

The composition ratio of the adhesive with respect to the pigment in the pigment coating layer coating solution is preferably in a range of about 5 parts by mass or more and about 50 parts by mass or less with respect to 100 parts by weight of the pigment. If the composition ratio of the adhesive with respect to 100 parts by mass of the pigment is less than about 5 parts by mass, the following problem occurs. First, the pigment coating layer coating solution is applied on the paper base material to form the pigment coating layer on the paper base material, but when further coating with the resin layer, the paper base material surface becomes soaked with the resin liquid, so that preferable white paper glossiness cannot be obtained. If the composition ratio of the adhesive with respect to 100 parts by mass of the pigment is more than about 50 parts by mass, bubbles may be generated when applying the pigment coating layer coating solution onto the paper base material, so as to cause roughness on the pigment coating surface, so that preferable white paper glossiness may not be obtained.

Various auxiliary agents may be added to the pigment coating layer coating solution as needed. Examples of the auxiliary agents include a surfactant, a pH adjusting agent, a viscosity adjusting agent, a softening agent, a glossiness providing agent, a dispersing agent, a flowability modifying agent, an electric conduction preventing agent, a stabilizing agent, a charge preventing agent, a cross-linking agent, an antioxidant, a sizing agent, a fluorescence intensifying agent, a coloring agent, an ultraviolet ray absorbing agent, an antifoaming agent, a waterproof agent, a plasticizer, a lubricant, an antiseptic, and a perfume.

The amount of the pigment coating layer coating solution applied to the paper is selected according to the application purpose of the paper of the invention. In general, an amount to the extent that the surface roughness of the paper is completely covered is needed. Therefore, the amount of the pigment coating layer coating solution applied to the paper is preferably in a range of about 2 g/m2 or more and about 8 g/m2 or less based on the dry mass.

As the method for further applying the pigment coating layer coating solution to the paper base material surface with the size press solution applied, a commonly known coating machine can be selected and used as needed. Examples of the commonly known coating machine include a blade coater, an air knife coater, a roll coater, a reverse roll coater, a bar coater, a curtain coater, a dye coater, a gravure coater, a champlex coater, a brush coater, a two roll or metering blade type size press coater, a bill blade coater, a short dwell coater, and a gate roll coater.

The pigment coating layer is formed on the paper base material as the surface layer of one or both sides of the paper. Then, the surface layer may be provided with one layer, or, as needed, two or more intermediate layers so as to provide a multiple layer structure. In the case where the surface layer is provided on both sides of the paper or the surface layer has a multiple layer structure, the coating amounts of the coating solutions for forming respective coating layers need not be same. In addition, the kind and the content of the materials included in the coating solutions for forming respective coating layers need not be same. The coating solution may be adjusted according to a required quality level so as to satisfy the above-identified ranges.

In the case where the pigment coating layer is provided on one side of the paper, a synthetic resin layer, a coating layer made of an adhesive and a pigment etc., a charge prevention layer, or the like may be provided on the other side, which makes it possible to provide the paper with the functions of, for example, preventing curl generation, improving printing suitability and paper feeding and discharging suitability.

Furthermore, it is also possible to provide the characteristics suitable for various applications to the paper by applying various processes to the other side of the paper, such as a post process of adhesion, magnetic property flame resistance, heat resistance, water resistance, oil resistance, and slip prevention.

Preferably, the paper of the invention is produced in such a manner that the sizing agent, the size press solution, the pigment coating layer coating solution, or the like is applied as needed to the paper base material surface, followed by a smoothing process with a smoothing process machine such as a super calender, a gross calender and a soft calender. The smoothing process may be applied as needed by on machine or off machine. The form of the pressuring machine, the number of pressure nips, heating, or the like may also be appropriately adjusted according to a standard smoothing process machine.

### —Various Physical Properties of the Paper—

The basis weight (JIS P-8124) of the paper of the invention, although not particularly limited thereto, is preferably about 60 g/m² or more. If the basis weight is less than about 60 g/m2, the rigidity of the paper is reduced; consequently, in a fixing device for fixing to a paper a toner image transferred onto the paper, image defects may easily occur at the time of forming an image with an image forming apparatus using an electrophotographic method, due to the occurrence of paper curling or peeling failure, which are problematic. Similarly, if the basis weight is less than about 60 g/m², the magnetic material contained in the paper can easily be disposed within a range of less than about 5 μm from the paper surface; consequently when forming an image with an image forming apparatus of the electrophotographic method or ink jet method, transfer voids may occur.

To increase the average moisture absorbing speed S2a so as to maintain the average moisture absorbing speed S2a at about 0.045 or more, the paper density is preferably 1.0 g/cm³ or less, and more preferably about 0.9 g/cm³ or less. If the density is more than about 1.0 g/cm³, the average moisture absorbing speed S2a may not be maintained at be about 0.045 or more. On the other hand, the lower limit of the paper density, although not particularly limited thereto, is preferably about 0.6 g/cm³ or more to restrain any increase of the paper thickness.

On the other hand, to reduce the average dehydration speed S1a so as to maintain the average dehydration speed S1a at about 0.15 or less, the stochigt sizing degree of the paper is preferably large, and specifically it is preferably about 40 seconds or more.

However, if the stochigt sizing degree is about 40 seconds or more in the case where the paper has only a paper base material with a single layer configuration, it is difficult to transfer the toner to the paper surface during image formation.

Accordingly, when the stochigt sizing degree is to be adjusted, it is preferable that the paper base material has a layer configuration having three paper base material layers and only the paper base material layer arranged at the central position with respect to a paper thickness direction contains the magnetic material. In this case, the stochigt sizing degree of the paper base material layer arranged at the central position with respect to a paper thickness direction is set to about 40 seconds or more, and the stochigt sizing degree of the paper base material layers arranged on both sides of the paper base material layer arranged at the central position with respect to a paper thickness direction is set to about 35 seconds or less. With this configuration, the average dehydration speed S1a can be reduced further, and occurrence of the toner transfer failure can be restrained.

According to the explanation so far, the stochigt sizing degree of the paper base material layer arranged at the central position with respect to a paper thickness direction is preferably about 40 seconds or more, more preferably about 45 seconds or more, and further preferably about 50 seconds or more. The upper limit value of the stochigt sizing degree, although not particularly limited thereto, is in practice preferably about 60 seconds or less.

On the other hand, the stochigt sizing degrees of the paper base material layers arranged on both sides of the paper base material layer arranged at the central position with respect to a paper thickness direction is preferably about 35 seconds or less, more preferably about 32 seconds or less, and further preferably about 30 seconds or less. The lower limit value of the stochigt sizing degree, although not particularly limited thereto, is in practice preferably about 5 seconds or more.

The stochigt sizing degree of the paper base material (or the paper base material layer) can be adjusted by, for example, mixing in an internally added sizing agent at the adjusting stage of the paper material slurry used for of the paper production.

In the invention, the stochigt sizing degree refers to the stochigt sizing degree based on the JIS P8122:1976 measured in the standard environment (temperature 23° C., relative humidity 50%) defined in the JIS P8111:1998.

Furthermore, the moisture content ratio of the paper of the invention after the moisture conditioning for 12 hours or more in a 23° C./50% RH environment of the paper of the invention is preferably in a range of about 4.0% by mass or more and about 7.0% by mass or less, and more preferably in a range of about 4.5% by mass or more and about 7.0% by mass or less. If the moisture content ratio is less than about 4.0% by mass or more than about 7.0% by mass, the image quality may be deteriorated when forming an image by the electrophotographic method.

The paper of the invention may be used also for forming an image utilizing a known recording method other than the electrophotographic method, such as an ink jet method.

### EXAMPLES

Although the invention will be explained in more detail with reference to Examples hereafter, the invention is not limited thereto. The same magnetic substance wire is used in the Examples and Comparative Examples.

### Example 1

A paper material slurry contains 95 parts by mass of a LBKP (broadleaf tree bleached kraft pulp) and 5 parts by mass of NBKP (conifer bleached kraft pulp), and to the slurry is added 0.15 parts by mass of cationized starch (trade name: MS4600, manufactured by Nippon Shokuhin Kagaku Kogyo Corp.) and 0.1 parts by mass of alkenyl succinic anhydride (trade name: Fiveran 81, manufactured by Nippon NSC Ltd.) with respect to 100 parts by mass of the pulp solid component.

Subsequently, 45 parts by weight of glycerol (refined glycerol, manufactured by Kao Corporation) as a moisture retaining agent and 5 pieces of a 20 μm diameter and 40 mm length magnetic substance wire (composition: Fe base) are further mixed with the paper material slurry.

The thus obtained paper material slurry (solid component concentration 1.0% by mass) is used to produce a paper sheet under the following conditions with an oriented paper machine (manufactured by Kumagai Riki Kogyo Co., Ltd.).

### <Paper Making Conditions>

Drum rotation speed: 1,000 rotations/min
Paper material slurry ejection pressure: 1.0 kgf/cm²
Number of strokes: 9 times

The produced sheet is pressed by a pressure of 10 kgf/cm2 for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.). As a result, a paper with a basis weight of 65 g/m2 is obtained. Detailed paper characteristics are shown in Table 1.

### Example 2

A paper is produced in the same manner as in Example 1 except that a paper material slurry with the glycerol amount changed to 5 parts by weight is used. The basis weight of the obtained paper is 68 g/m². Detailed paper characteristics are shown in Table 1.

### Example 3

Two sheets containing no magnetic material are produced independently in the same manner as in Example 1, except that a paper material slurry, also prepared in the same manner as in Example 1, does not include a moisture retaining agent and a magnetic material, and that the number of the strokes of the paper making conditions in Example 1 is changed to 4 times. The basis weights of the sheets are 31 g/m² (hereafter, the sheet is referred to as “sheet A3”) and 32 g/m² (hereafter, the sheet is referred to as “sheet C3”).

Subsequently, a sheet having a basis weight of 31 g/m² is produced (hereafter, the sheet is referred to as “sheet B4”) in the same manner as in Example 1, except that a paper material slurry, also prepared in the same manner as in Example 1, does not include a moisture retaining agent, and that the number of the strokes of the paper making conditions in Example 1 is changed to 4 times.

The produced three sheets are pressed independently by a pressure of 10 kgf/cm² for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.).

Then, a polyester resin (trade name: MD-1985, manufactured by Toyobo Co., Ltd.) is coated with a blade coater onto the front and rear surfaces of a sheet B3 at 3 g/m² per side. After coating, sheet B3 is clamped immediately between sheet A3 and sheet C3 to be dried twice at a heating temperature of 100° C. and a rotation speed of 50 cm/min with a KRK rotational drier (manufactured by Kumagai Riki Kogyo Co., Ltd.). Thereby, a paper having a basis weight of 100 g/m² having a layer configuration with the three paper base material layers bonded with an adhesive layer serving as a barrier layer is obtained. Detailed paper characteristics are shown in Table 1.

### Example 4

A paper material slurry contains 95 parts by mass of a LBKP (broadleaf tree bleached kraft pulp) and 5 parts by mass of NBKP (conifer bleached kraft pulp); added to the slurry are 0.05 parts by mass of cationized starch (trade name: MS4600, manufactured by Nippoon Shokuhin Kagaku Kogyo Corp.) and 0.05 parts by mass of alkenyl succinic anhydride (trade name: Fiveran 81, manufactured by Nippon NSC Ltd.) with respect to 100 parts by mass of the pulp solid component.

Subsequently, 5 pieces of a 20 μm diameter and 40 mm length magnetic substance wire (composition: Fe base) are further mixed with the paper material slurry.

The thus obtained paper material slurry (solid component concentration 1.0% by mass) is used to produce a paper sheet under the following conditions with an oriented paper machine (manufactured by Kumagai Riki Kogyo Co., Ltd.).

### <Paper Making Conditions>

Drum rotation speed: 1,000 rotations/min
Paper material slurry ejection pressure: 1.0 kgf/cm²
Number of strokes: 9 times

The produced sheet is pressed by a pressure of 10 kgf/cm² for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.). As a result, a paper with a basis weight of 66 g/m² is obtained. Detailed paper characteristics are shown in Table 1.

### Example 5

Two sheets containing no magnetic material are produced independently in the same manner as in Example 1, except that a paper material slurry, also prepared in the same manner as in Example 1, does not include a moisture retaining agent and a magnetic material, and that the number of the strokes of the paper making conditions in Example 1 is changed to 4 times. The basis weights of the sheets are 35 g/m² (hereafter, the sheet is referred to as “sheet A4”) and 34 g/m² (hereafter, the sheet is referred to as “sheet C4”).

Subsequently, in a paper material slurry containing 95 parts by mass of a LBKP (broadleaf tree bleached kraft pulp) and 5 parts by mass of NBKP (conifer bleached kraft pulp), 0.15 parts by mass of cationized starch (trade name: MS4600, manufactured by Nippoon Shokuhin Kagaku Kogyo Corp.) and 0.6 parts by mass of alkenyl succinic anhydride (trade name: Fiveran 81, manufactured by Nippon NSC Ltd.) are added with respect to 100 parts by mass of the pulp solid component. To this 5 pieces of a 20 μm diameter and 40 mm length magnetic substance wire (composition: Fe base) are mixed.

The thus obtained paper material slurry (solid component concentration 1.0% by mass) is used to make a paper under the following paper making conditions with an oriented paper machine (manufactured by Kumagai Riki Kogyo Co., Ltd.) so as to produce a sheet with a basis weight of 36 g/m² (hereafter, the sheet is referred to as “sheet B4”).

### <Paper Making Conditions>

Drum rotation speed: 1,000 rotations/min
Paper material slurry ejection pressure: 1.0 kgf/cm²
Paper material ejection angle: 60°
Number of strokes: 4 times

With the produced three sheets laminated such that the sheet B is arranged between the sheet A and the sheet C so as to be the central layer (center layer), they are pressed by a pressure of 10 kgf/cm² for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.). Thereby, a paper with basis weight of 105 g/m² having a layer configuration with the three paper base material layers laminated is obtained. Detailed paper characteristics are shown in Table 1.

### Comparative Example 1

In a paper material slurry containing 95 parts by mass of a LBKP (broadleaf tree bleached kraft pulp) and 5 parts by mass of NBKP (conifer bleached kraft pulp), 0.15 parts by mass of cationized starch (trade name: MS4600, manufactured by Nippoon Shokuhin Kagaku Kogyo Corp.) and 0.2 parts by mass of alkenyl succinic anhydride (trade name: Fiveran 81, manufactured by Nippon NSC Ltd.) are added with respect to 100 parts by mass of the pulp solid component.

The thus obtained paper material slurry (solid component concentration 1.0% by mass) is used to produce two paper sheets under the following conditions with an oriented paper machine (manufactured by Kumagai Riki Kogyo Co., Ltd.).

### <Paper Making Conditions>

Drum rotation speed: 1,000 rotations/min
Paper material slurry ejection pressure: 1.0 kgf/cm²
Number of strokes: 4 times

The produced sheets are pressed by a pressure of 10 kgf/cm² for one minute with a square sheet machine press (manufactured by Kumagai Riki Kogyo Co. Ltd.), and then dried at a heating temperature of 100° C. and a rotation speed of 100 cm/min with a KRK rotational drier (manufactured by Kumagai Riki Kogyo Co., Ltd.) so as to obtain a sheet A′1 (basis weight of 32 g/m²) and a sheet C′1 (basis weight of 33 g/m²).

A sheet (sheet B′1) is produced under the following conditions using the same paper material slurry as in Example 4.

### <Paper Making Conditions>

Drum rotation speed: 1,000 rotations/min
Paper material slurry ejection pressure: 1.0 kgf/cm²
Number of strokes: 4 times

The produced sheet is pressed by a pressure of 10 kgf/cm² for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.) so as to obtain a sheet B′1 (basis weight of 34 g/m²).

With the produced three sheets laminated such that the sheet B′1 is arranged between the sheet A′1 and the sheet C′1 so as to be the central layer (center layer), they are pressed by a pressure of 10 kgf/cm² for one minute with a square sheet machine press (manufactured by Kumagai Riki Kogyo Co., Ltd.), and then dried at a heating temperature of 100° C. and a rotation speed of 100 cm/min with a KRK rotational drier (manufactured by Kumagai Riki Kogyo Co., Ltd.). Thereby, a paper with a basis weight of 99 g/m² having a layer configuration with the three paper base material layers laminated is obtained. Detailed paper characteristics are shown in Table 1.

### —Evaluation—

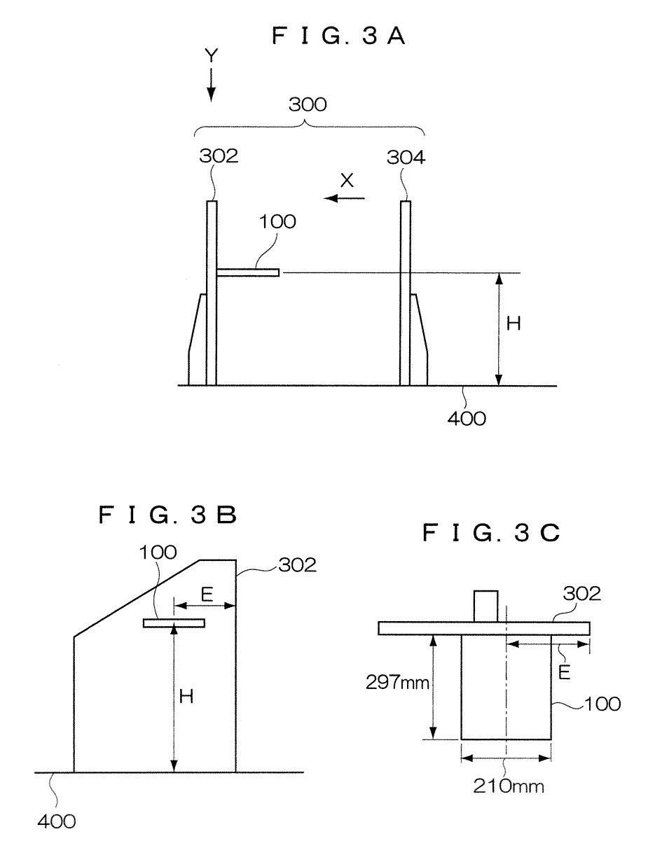

For evaluating the accuracy of the detection of the presence of the paper, a pulse signal derived from the magnetic material contained in the paper is measured using the detection gate shown in FIG. 3 (magnetic wire system article monitoring system, trade name: SAS, manufactured by Unipulse Corporation).

The detection gate used for the evaluation has a pair of two detecting devices including an excitor coil for forming an alternating magnetic field and a detection coil for detecting the magnetic inversion of the magnetic substance wires in the paper 100. FIG. 3 is a schematic diagram showing the configuration of the detection gate used for the evaluation of the examples. FIG. 3A is a front view of the detection gate. FIG. 3B is a side view of one detecting device constituting the detection gate (observing from the direction of the X arrow in FIG. 3A). FIG. 3C is a top view of one detecting device constituting the detection gate (observing from the direction of the Y arrow in FIG. 3A). In the figures, reference numeral 100 denotes a paper (A4 size), 300 denotes a detection gate, 302 denotes a first detecting device, 304 denotes a second detecting device, and 400 denotes a floor surface. Symbol H represents the height from the floor surface 400 to the paper 100, and symbol E represents the distance from a side end portion of the first detecting device 302 to a point at the center of a short edge of the paper 100.

As shown in FIG. 3, the detection gate 300 has the first detecting device 302 and the second detecting device 304 arranged facing with each other on the floor surface 400. The detecting devices 302 and 304 have the same configuration, with a height of about 1.5 m. The distance between the two detecting devices 302, 304 is about 0.9 m.

Here, the pulse signal is measured in a 2320 C./30% RH environment and the paper 100 is placed without moving, and is parallel to the floor surface as shown in FIG. 3 such that a shorter side of the paper 100 contacts with the side surface of the detecting device 302 that faces the side of the detecting device 304. The height H from the floor surface 400 to the paper 100 is 1,250 mm, and the distance E from the side end portion of the detection gate 302 to a center point of a shortedge of the paper 100 is 200 mm. At the time of the measurement, the maximum intensity of the alternating magnetic field at the height H from the floor surface and the distance E from the side end portion of the detecting device 302 is set at 9. 2 Oe in the plane of the detecting device 302 that contacts the paper.

The pulse signal detected by the detection gate 300 is taken into a digital oscilloscope (trade name: DL1540, manufactured by Yokogawa Electric Corporation) and a pulse value is set to the voltage of a pulse peak value.

A pulse value of the paper before fixation (initial pulse value) and a pulse value after the image formation by an image forming apparatus (pulse value after fixation) are measured for each of the papers produced in the Examples and Comparative Examples.

Here, an initial pulse value is measured after moisture conditioning of the paper before the image formation test for 12 hours or more in the 23° C./50% RH environment.

The pulse value after fixation is measured as follows. A blank image is printed on both sides of the plain paper in a standard “A” mode and a full color mode with an image forming apparatus (trade name: DocuCentreColor f450, manufactured by Fuji Xerox Co., Ltd.) using the paper that has been moisture conditioned for 12 hours or more in a 23° C./50% RH environment before the image formation test. Then. after printing on both sides, the paper is moved to the detection gate 300 so as to be arranged as shown in FIG. 3.

Here, the pulse value after fixation denotes the pulse value measured after 30 seconds from the point immediately after being discharged from the image forming apparatus (immediately after the second fixation) after finishing the operation wherein both sides of the paper are printed.

The reason why the pulse value is measured after 30 seconds from the second fixation is based on a typical case in which, in an office with the detection gate arranged at the entrance of a room having with an image forming apparatus, the paper is carried to the outside of the room by a person who has outputted the image with the image forming apparatus.

Then, a pulse value change amount T (%) is calculated based on the following Formula (5) from the initial pulse value and the pulse value after fixation. The results are shown in Table 1.

Pulse value change amount T=(pulse value after fixation/initial pulse value)×100 Formula (5)

It can be said that with a smaller pulse value change amount T, the paper detection accuracy tends to decrease.

The determination criteria of the evaluation grade shown in Table 1 are as follows.
G0: T is 80 or more and 100 or less
G1: T is 50 or more and less than 80
G2: T is 30 or more and less than 50
G3: T is less than 30

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

TABLE 1

| | | | | | | | Comparative |
|---|---|---|---|---|---|---|---|
| | | Example 1 | Example 2 | Example 3 | Example 4 | Example 5 | example 1 |
| Dehydration | Average dehydration | 0.09 | 0.14 | 0.12 | 0.24 | 0.12 | 0.17 |
| and moisture | speed S1a | | | | | | |
| absorbing | (% by mass/second) | | | | | | |
| characteristics | Average moisture | 0.03 | 0.03 | 0.02 | 0.07 | 0.05 | 0.03 |
| of paper | absorbing speed S2a | | | | | | |
| | (% by mass/second) | | | | | | |
| | \|S2a/S1a\| | 0.33 | 0.21 | 0.17 | 0.29 | 0.42 | 0.18 |
| Layer | Number of layers in | 1 | 1 | 3 | 1 | 3 | 3 |
| structure of | paper base material | | | | | | |
| paper base | layer | | | | | | |
| material | Existence of barrier | No | No | Yes | No | No | No |
| | layer | | | | | | |
| | Stochigt sizing degree | 25 | 26 | — | 13 | 28/55/25 | 38/14/37 |
| | of paper base material | | | | | | |
| | layer (or each paper | | | | | | |
| | base material layer) | | | | | | |
| | (second) | | | | | | |
| Additives | Moisture retaining | 45 | 5 | — | — | — | — |
| | agent (parts by | | | | | | |
| | mass/100 parts by mass | | | | | | |
| | of pulp fiber) | | | | | | |
| Other paper | Basis weight (g/m²) | 65 | 68 | 100 | 66 | 105 | 99 |
| physical | Density (g/cm³) | 0.83 | 0.88 | 0.94 | 0.81 | 0.93 | 0.92 |
| property | Paper thickness (μm) | 78 | 77 | 106 | 82 | 113 | 108 |
| values | Moisture content ratio | 6.6 | 5.8 | 4.6 | 5.5 | 6.4 | 6.4 |
| | after moisture | | | | | | |
| | conditioning | | | | | | |
| | (% by mass) | | | | | | |
| Evaluation | Grade evaluation of | G0 | G2 | G1 | G1 | G0 | G3 |
| result | pulse value change | | | | | | |
| | amount T | | | | | | |

What is claimed is:

1. A transfer paper for electrophotography comprising:
at least a pulp fiber and a magnetic material for generating a large Barkhausen effect,
and having an average dehydration speed S1a of about 0.15 or less,
the average dehydration speed S1a (% by mass/second) denoting an average value of dehydration speeds S1 of 5 sheets of paper, and the dehydration speed S1 denoting a value represented by the following Formula (1):
Dehydration speed S1=(W1a−W1b)/30 Formula (1)
in the Formula (1), W1a represents a moisture content ratio (% by mass) of the paper after moisture conditioning for 12 or more hours in a 23° C./50% RH environment, W1b represents a moisture content ratio (% by mass) of the paper after a dehydration process including leaving the paper in a 80° C. environment for 30 seconds after the moisture conditioning for 12 or more hours in a 23° C./50% RH environment, and the constant value shown as the denominator in the formula denotes a time (30 seconds) needed for the dehydration process.

2. The transfer paper for electrophotography of claim 1, wherein the magnetic material is a wire-like magnetic material having a length in a range of about 10 mm to about 430 mm, and a diameter in a range of about 10 μm to about 90 μm.

3. The transfer paper for electrophotography of claim 1, comprising a layer containing at least the pulp fiber and the magnetic material, and a barrier layer containing a barrier material, wherein the barrier layer is arranged on both sides of the layer containing at least the pulp fiber and the magnetic material.

4. The transfer paper for electrophotography of claim 1, wherein the moisture content ratio of the paper after moisture conditioning for 12 or more hours in a 23° C./50% RH environment is in a range of about 4.0% by mass to about 7.0% by mass.

5. The transfer paper for electrophotography of claim 1, comprising a paper base material containing the pulp fiber and the magnetic material, wherein the paper base material comprises three paper base material layers.

6. The transfer paper for electrophotography of claim 5, wherein the magnetic material is contained in the paper base material layer arranged at the middle in a paper thickness direction.

7. The transfer paper for electrophotography of claim 5, wherein the stochigt sizing degree of the paper base material layer arranged at the middle in a paper thickness direction is 40 seconds or more, and the stochigt sizing degree of the paper base material layers arranged on both sides of the paper base material layer arranged at the middle in a paper thickness direction is 35 seconds or less.

8. A transfer paper for electrophotography comprising:
at least a pulp fiber and a magnetic material for generating a large Barkhausen effect,
and having an average moisture absorbing speed S2a of about 0.045 or more,
the average moisture absorbing speed S2a (% by mass/second) denoting an average value of moisture absorbing speeds S2 of 5 sheets of paper, and the moisture absorbing speed S2 denoting a value represented by the following Formula (2):
Moisture absorbing speed S2=(W2b−W2a)/30 Formula (2)
in the Formula (2), W2a represents a moisture content ratio (% by mass) in the paper after moisture conditioning for 12 or more hours in a 10° C./15% RH environment, W2b represents a moisture content ratio (% by mass) of the paper after a moisture absorbing process including leaving the paper in a 28° C./85% RH environment for 30 seconds after moisture conditioning for 12 or more hours in a 10° C./15% RH environment, and the constant value shown as the denominator in the formula denotes a time (30 seconds) needed for the moisture absorbing process.

9. The transfer paper for electrophotography of claim 8, wherein the moisture content ratio of the paper after moisture conditioning for 12 or more hours in a 23° C./50% RH environment is in a range of about 4.0% by mass to about 7.0% by mass.

10. The transfer paper for electrophotography of claim 8, comprising a paper base material containing the pulp fiber and the magnetic material, wherein the paper base material comprises three paper base material layers.

11. A transfer paper for electrophotography comprising:
at least a pulp fiber and a magnetic material for generating a large Barkhausen effect,
and having a dehydration and moisture absorbing speed ratio R, according to Formula (3), of about 0.3 or more:
Dehydration and moisture absorbing speed ratio R=|average moisture absorbing speed S2a/average dehydration speed S1a| Formula (3)
in the Formula (3), the average dehydration speed S1a (% by mass/second) denotes an average value of dehydration speeds S1 of 5 sheets of paper, and here the dehydration speed S1 denotes a value represented by the following Formula (4), while the average moisture absorbing speed S2a (% by mass/second) denotes an average value of moisture absorbing speeds S2 of 5 sheets of paper, and here the moisture absorbing speed S2 denotes a value represented by the following Formula (5):
Dehydration speed S1=(W1a−W1b)/30 Formula (4)
in the Formula (4), W1a represents a moisture content ratio (% by mass) in the paper after moisture conditioning for 12 or more hours in a 23° C./50% RH environment, W1b represents a moisture content ratio (% by mass) of the paper after a dehydration process including leaving the paper in a 80° C. environment for 30 seconds after moisture conditioning for 12 or more hours in a 23° C./50% RH environment, and the constant value shown as the denominator in the formula denotes a time (30 seconds) needed for the dehydration process:
Moisture absorbing speed S2=(W2b−W2a)/30 Formula (5)
in the Formula (5), W2a represents a moisture content ratio (% by mass) in the paper after moisture conditioning for 12 or more hours in a 10° C./15% RH environment, W2b represents a moisture content ratio (% by mass) of the paper after a moisture absorbing process including leaving the paper in a 28° C./85% RH environment for 30 seconds after moisture conditioning for 12 or more hours in a 10° C./15% RH environment, and the constant value shown as the denominator in the formula denotes a time (30 seconds) needed for the moisture absorbing process.

12. The transfer paper for electrophotography of claim 11, comprising a layer containing at least the pulp fiber and the magnetic material, and a barrier layer containing a barrier material, wherein the barrier layer is arranged on both sides of the layer containing at least the pulp fiber and the magnetic material.

13. The transfer paper for electrophotography of claim 11, wherein the moisture content ratio of the paper after moisture conditioning for 12 or more hours in a 23° C./50% RH environment is in a range of about 4.0% by mass to about 7.0% by mass.

14. The transfer paper for electrophotography of claim 11, comprising a paper base material containing the pulp fiber and the magnetic material, wherein the paper base material comprises three paper base material layers.

15. A transfer paper for electrophotography comprising:
at least a pulp fiber and a magnetic material for generating a large Barkhausen effect,
a process being applied to the paper to improve moisture retaining properties.

16. The transfer paper for electrophotography of claim 15, comprising a layer containing at least the pulp fiber and the magnetic material, and a barrier layer containing a barrier material, wherein the barrier layer is arranged on both sides of the layer containing at least the pulp fiber and the magnetic material.

17. The transfer paper for electrophotography of claim 15, wherein the moisture content ratio of the paper after moisture conditioning for 12 or more hours in a 23° C./50% RH environment is in a range of about 4.0% by mass to about 7.0% by mass.

18. The transfer paper for electrophotography of claim 15, comprising a paper base material containing the pulp fiber and the magnetic material, wherein the paper base material comprises three paper base material layers.
